(19) United States
(12) Patent Application Publication
(10) Pub. No.: US 2013/0015688 A1
(43) Pub. Date: Jan. 17, 2013

(54) MOTORCYCLE SEAT COVER

(71) Applicant: Ismael IBARRA, Chaparral, NM (US)

(72) Inventor: Ismael IBARRA, Chaparral, NM (US)

(21) Appl. No.: 13/546,677

(22) Filed: Jul. 11, 2012

Related U.S. Application Data
(60) Provisional application No. 61/506,259, filed on Jul. 11, 2011.

(51) Int. Cl. B62J 1/20

(52) U.S. Cl. 297/219.11

(57) ABSTRACT

A motorcycle seat shield comprising: an oval shaped body; a loop enclosure; and a drawstring, where the drawstring travels through the loop enclosure. The oval shaped body may be made of an aluminum foil. Further, the oval shaped body provides a waterproof and heat resistant shield for the motorcycle seat.

### CROSS REFERENCE TO OTHER APPLICATIONS

This application claims priority to U.S. Provisional Application Ser. No. 61/506,259 filed on Jul. 11, 2012.

### BACKGROUND OF THE INVENTION

1. Field of Invention

The present invention relates to a motorcycle seat cover that conveniently covers and seals the seat from environmental conditions such as sun, water and dust.

2. Description of Related Art

Motorcycle riders must sit on a seat throughout the operation of a motorcycle. Motorcycle seats come in various sizes and shapes to provide a comfortable seat for various drivers. One of the problems associated with motorcycle seats relate to exposure to sun and rain that may cause damage to the appearance and comfort of the seat over a period of time. Most of the time many motorcyclists leave their motorcycle parked outdoors and therefore the seat is exposed to various weather conditions. Exposure to the sun and rain can cause the seat to crack and diminish the life of the seat. Consequently it would be advantageous to have a cover or shield to place over the seat when the seat is not in use by the driver. A special shield could protect the seat from the sun, rain and dust conditions while it's parked.

### SUMMARY OF THE INVENTION

The present invention relates to a motorcycle seat shield comprising: an oval shaped body; a loop enclosure; and a drawstring, where the drawstring travels through the loop enclosure. The oval shaped body may be made of an aluminum foil. Further, the oval shaped body provides a waterproof and heat resistant shield for the motorcycle seat.

### BRIEF DESCRIPTION OF DRAWINGS

FIG. 1 depicts a motorcycle with a motorcycle shield cover in accordance with present invention.

FIG. 2 depicts a perspective view of the motorcycle shield cover in accordance with the present invention.

### DETAILED DESCRIPTION

The present invention relates to a motorcycle shield cover that is easily installed over a motorcycle seat to protect the seat from environmental conditions. The seat cover in accordance with the present invention includes a foil material that is both waterproof and heat resistant to protect the seat from the sun and rain. The seat shield cover includes a drawstring that allows the user to secure the shield over the seat and firmly place the shield in place. Because of the flexibility of drawstring and oval shape of the shield a user may easily place the shield over various shapes and sizes of motorcycle seats.

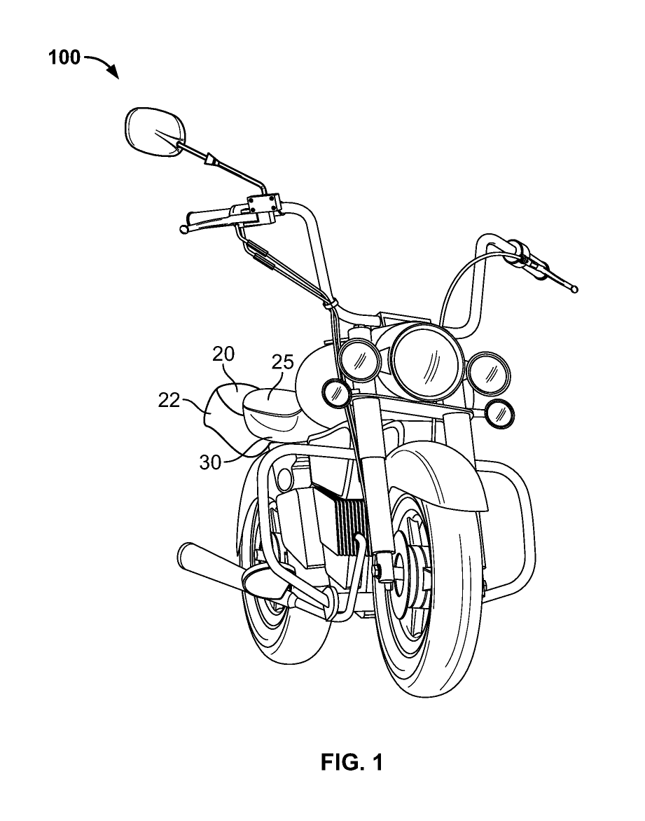

In reference to FIG. 1, a motorcycle 100 is depicted. The motorcycle 100 includes a seat 30 where a shield cover 25 is placed over the surface thereof. The shield cover 25 is secured through the use of the drawstring with a first end 20 and a second end 22. A user may simply place and secure the shield over the seat and tighten the drawstring to tie the shield in place to cover the motorcycle seat.

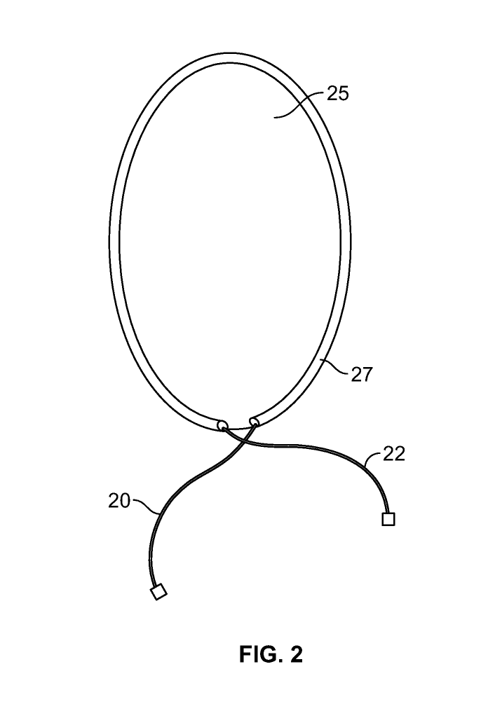

FIG. 2 depicts a perspective view of the motorcycle shield cover 25 in accordance with the present invention. The motorcycle shield cover 25 as shown includes a foil shield surface with a loop enclosure 27 surrounding the perimeter of the shield cover 25. The loop enclosure 27 encloses a drawstring that includes a first end 20 and a second end 22. As stated a user simply places the shield over a motorcycle seat and then tightens the drawstring to secure the shield in place to protect the seat from exposure to the environmental conditions.

In the preferred embodiment, the shield cover is oval in shape to provide the most flexibility and use over various motorcycle seat shapes. Further the shield is comprised of an aluminum foil that is waterproof and heat resistant. Use of the shield cover in accordance with the present invention should assist the user in protecting and preserving the seat of a motorcycle. Use of the shield cover prevents the user from having to endure any overheated seats due to sun exposure or having to deal with an extremely soaked seat from a rainfall. The instant invention has been shown and described in what it considers to be the most practical and preferred embodiments. It is recognized, however, that departures may be made there from within the scope of the invention and that obvious modifications will occur to a person skilled in the art.

What is claimed is:

1. A motorcycle seat shield comprising:
a. an oval shaped body;
b. a loop enclosure; and
c. a drawstring, where the drawstring travels through the loop enclosure.

2. The motorcycle according to claim 1, where the oval shaped body is made of an aluminum foil.

3. The motorcycle according to claim 1, where the oval shaped body is waterproof and heat resistant.
